(19) United States
(12) Patent Application Publication
(10) Pub. No.: US 2003/0223154 A1
(43) Pub. Date: Dec. 4, 2003

(54) Method for encapsulation of a U shape micro-actuator

(76) Inventor: Ming Gao Yao, Dongguan City (CN)

Correspondence Address: Kenyon & Kenyon, Suite 600, 333 W. San Carlos Street, San Jose, CA, 95110, US

(21) Appl. No.: 10/263,001

(22) Filed: Oct. 1, 2002

(30) Foreign Application Priority Data
May 31, 2002 (WO) PCT/CN02/00374

(51) Int. Cl. G11B 5/55

(52) U.S. Cl. 360/265.7

(57) ABSTRACT

A system and method for preventing particle generation by the micro-actuator during deformation by partially encapsulating the micro-actuator with a coating is disclosed. The coating may be made of a soft and tenacious material. The coating may be applied to the rigid areas of the micro-actuator.

### BACKGROUND INFORMATION

The present invention relates to magnetic hard disk drives. More specifically, the present invention relates to a method of preventing particle generation by the actuator of the hard disk drive.

In the art today, different methods are utilized to improve recording density of hard disk drives. FIG. 1 provides an illustration of a typical drive arm configured to read from and write to a magnetic hard disk. Typically, voice-coil motors (VCM) 102 are used for controlling a hard drive's arm 104 motion across a magnetic hard disk 106. Because of the inherent tolerance (dynamic play) that exists in the placement of a recording head 108 by a VCM 102 alone, micro-actuators 110 are now being utilized to ‘fine-tune’ head 108 placement. A VCM 102 is utilized for course adjustment and the micro-actuator then corrects the placement on a much smaller scale to compensate for the VCM's 102 (with the arm 104) tolerance. This enables a smaller recordable track width, increasing the ‘tracks per inch’ (TPI) value of the hard drive (increased drive density).

FIG. 2 provides an illustration of a micro-actuator as used in the art. Typically, a slider 202 (containing a read/write magnetic head; not shown) is utilized for maintaining a prescribed flying height above the disk surface 106 (See FIG. 1). Micro-actuators may have flexible beams 204 connecting a support device 206 to a slider containment unit 208 enabling slider 202 motion independent of the drive arm 104 (See FIG. 1). An electromagnetic assembly or an electromagnetic/ferromagnetic assembly (not shown) may be utilized to provide minute adjustments in orientation/location of the slider/head 202 with respect to the arm 104 (See FIG. 1).

The slider may be bonded with a ‘U’ shaped micro-actuator. The ‘U’-shaped micro-actuator may have a piezoelectric Lead Zirconate Titanate (PZT) beam (arm) on each side of a Zirconia support frame (actuator base). During excitation of the PZT, the PZT beam will deform, further causing the Zirconia support frame to deform. Since the PZT is an anisotropic structure, meaning the Weiss domains will increase the alignment proportionally, and since the top surface of the PZT is a soft, electric material (i.e., gold or platinum), the PZT does not generate any particles during this deformation. However, as the Zirconia support frame is a hard material lacking the Weiss domain properties, the inner force present during deformation generates particles. Particle generation is particularly heavy on the inside surface of the ‘U’ shaped micro-actuator where the interior forces are strongest. Particles generated on the ‘U’ shaped micro-actuator may interfere with the operation of the actuator. Additionally, these particles may be deposited on the magnetic disk surface, interfering with read/write operations. Also, the particles eventually cause damage to the micro-actuator arm as the hard drive ages. Further, since both arms of the “U” shape micro-actuator support the head, the arm may be broken due to shock or vibration. It is therefore desirable to decrease the amount of particle generation caused by the Zirconia support frame.

### BRIEF DESCRIPTION Of The DRAWINGS

FIG. 1 provides an illustration of a drive arm configured to read from and write to a magnetic hard disk as used in the art.

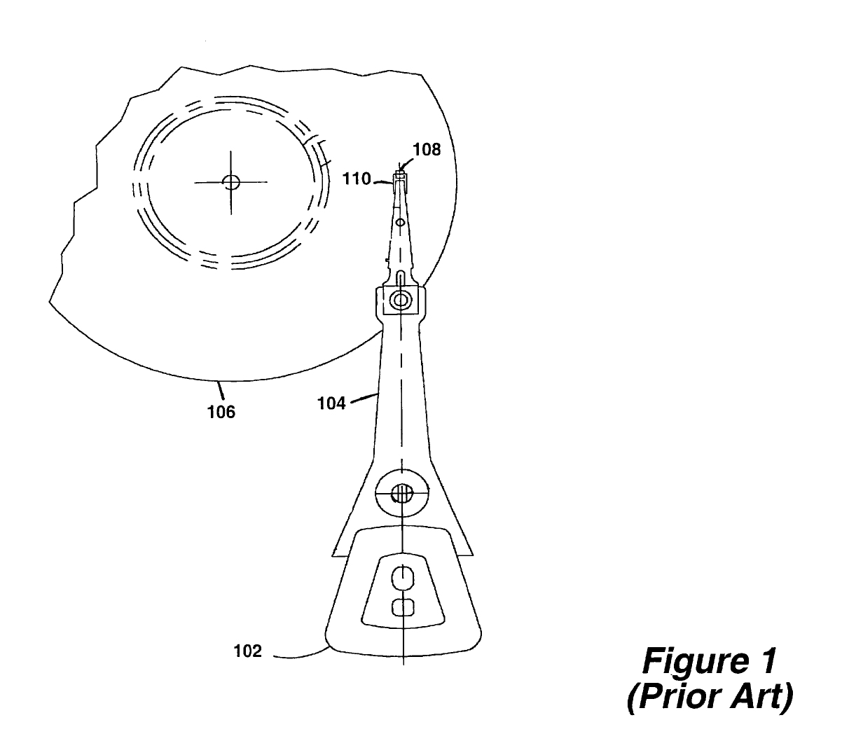

FIG. 2 provides an illustration of a micro-actuator as used in the art.

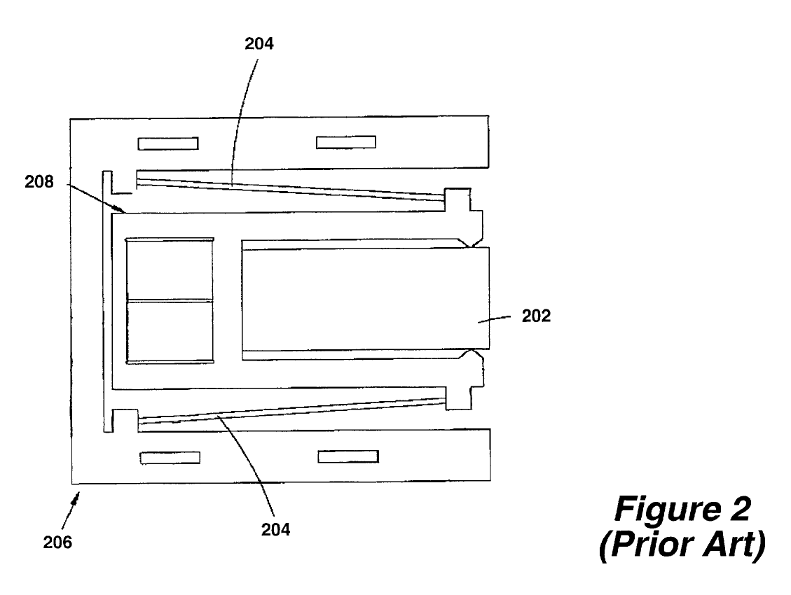

FIG. 3 describes a hard disk drive head gimbal assembly (HGA) with a ‘U’-shaped micro-actuator under principles of the present invention.

FIG. 4 provides an illustration of a U shape micro-actuator design.

FIG. 5 provides an illustration of the U shape micro-actuator bending with slider.

FIG. 6 provides an illustration of an encapsulated U shape micro-actuator.

### DETAILED DESCRIPTION

A system and method for preventing particle generation by the micro-actuator during deformation by partially encapsulating the micro-actuator with a coating is disclosed. In one embodiment, the coating, made of a soft and tenacious material, is applied to the rigid areas of the micro-actuator.

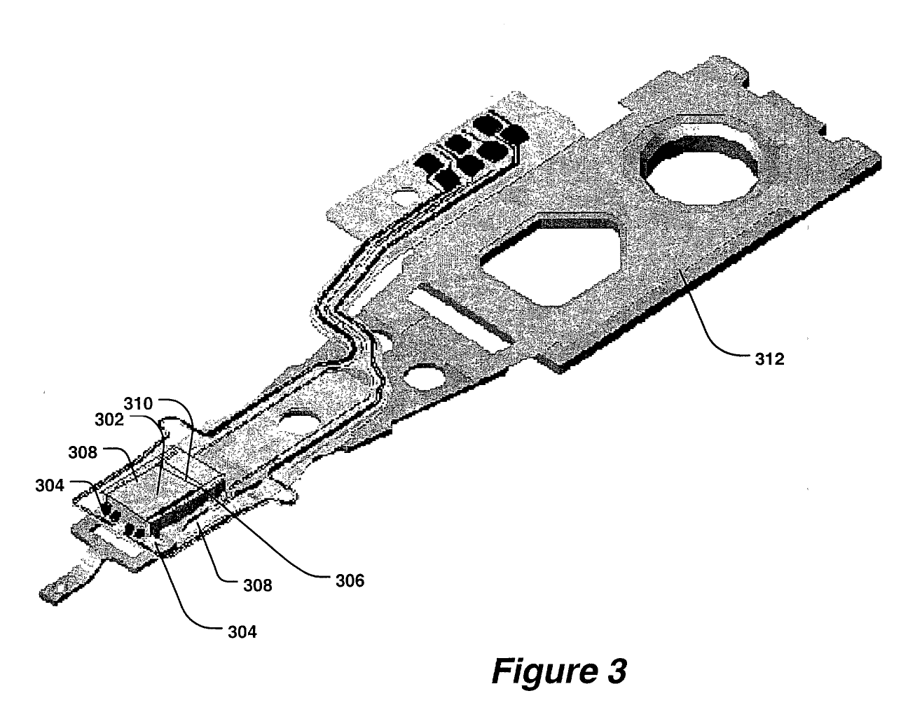

Illustrated in an upside-down orientation, FIG. 3 describes one embodiment of a hard disk drive head gimbal assembly (HGA) with a ‘U’-shaped micro-actuator. In one embodiment, a slider 302 is bonded at two points 304 to a ‘U’-shaped micro-actuator 306. In a further embodiment, the ‘U’-shaped micro-actuator has a piezoelectric Lead Zirconate Titanate (PZT) beam (arm) 308 on each side of a Zirconia support frame (actuator base) 310. The micro-actuator 306 is coupled to a suspension 312.

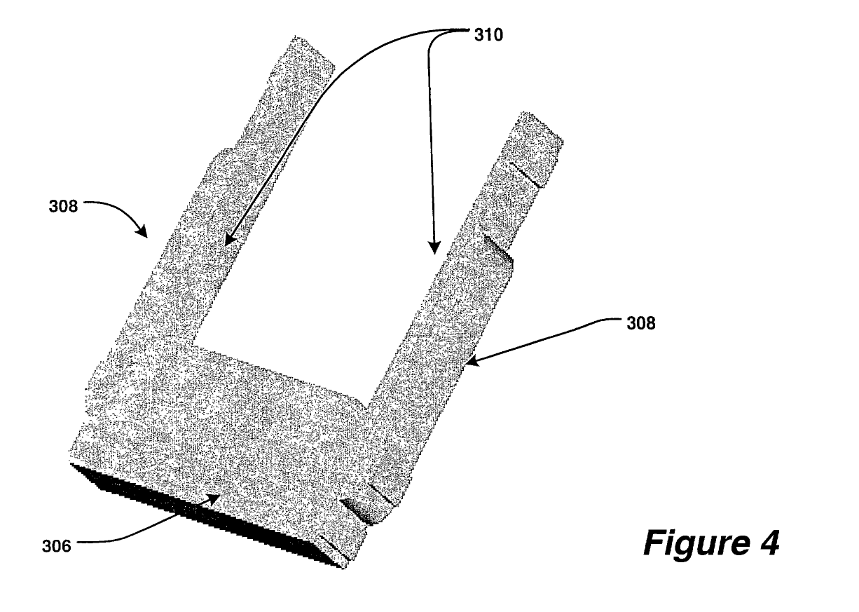

FIG. 4 illustrates one embodiment of the ‘U’ shaped micro-actuator 306. A support frame 310 supports two piezoelectric Lead Zirconate Titanate (PZT) beams 308. In one embodiment, the support frame is Zirconia. While the PZT beams cover the exterior sides of each of the two arms of the ‘U’ shaped micro-actuator 306, the Zirconia support frames on the interior sides of the arms are exposed.

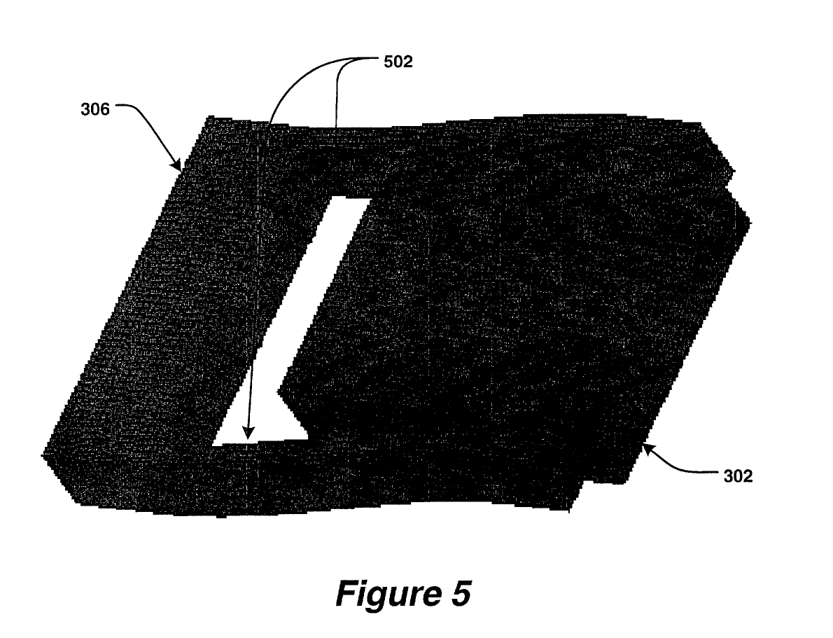

FIG. 5 illustrates the interaction between the ‘U’ shaped micro-actuator 306 and a slider 302. As the micro-actuator drives the slider, the arms of the micro-actuator deform. Because the PZT beams are anisotropic structures and the top surfaces of the PZT beams are typically a soft, electric material (i.e., gold or platinum), particle generation by the PZT beam is not sufficient to be problematic. However, the support frame is typically made of a rigid material and does not have the proper Weiss domain properties to reduce particle generation. The deformation of the arms of the micro-actuator causes the support frame to generate particles along the exposed interior of the arms 502.

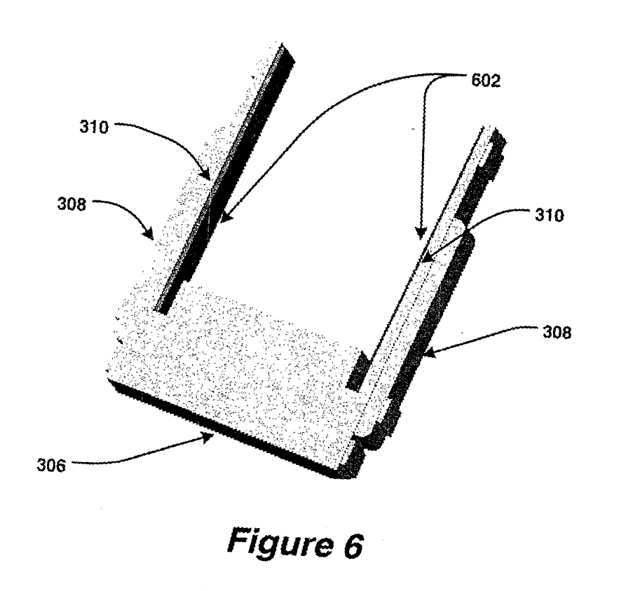

In one embodiment of the present invention, an encapsulation coating is applied to the ‘U’ shaped micro-actuator to prevent particle generation. FIG. 6 illustrates an example of a partially encapsulated ‘U’ shaped micro-actuator. According to an embodiment of the present invention, to avoid affecting the performance of the micro-actuator, the encapsulation coating 602 only partially covers the micro-actuator 306. In one embodiment, the encapsulation covers the exposed support frame 310 on the interior side of the arms. In a further embodiment, the encapsulation coating is made of a soft and tenacious material, such as gold, platinum, epoxy resin, etc. The encapsulation coating can be applied to the support frame 310 with any of a variety of techniques including printing, spraying, sputtering, electric plating, electricless plating, or chemical vapor deposition. Other methods may also be used to apply the coating. In one embodiment, the coating operation occurs before the PZT arms are coupled to the support frame.

The encapsulation coating can increase the shock performance of the “U” shape micro-actuator. Such shocks include a tilt drop shock or a crash-stop shock during a head seek. The particle encapsulated method can increase the shock stiffness of the arms of the “U” shape micro-actuator and thereby improve shock performance.

Although several embodiments are specifically illustrated and described herein, it will be appreciated that modifications and variations of the present invention are covered by the above teachings and within the purview of the appended claims without departing from the spirit and intended scope of the invention.

1. An actuator, comprising:
an actuator element having a generally ‘U’-shaped structure, the actuator including a support frame of a first material; and
a coating at least partially encapsulating the actuator element to prevent particle generation, the coating comprising a second material.

2. The actuator of claim 1, wherein the actuator element is a micro-actuator.

3. The actuator of claim 1, wherein the micro-actuator is a piezoelectric micro-actuator.

4. The actuator of claim 1, wherein the first material is Zirconia.

5. The actuator of claim 1, wherein the second material is softer than the first material.

6. The actuator of claim 1, wherein the second material is selected from a group consisting of an epoxy, a resin, and a soft metal.

7. The actuator of claim 1, wherein the coating is applied by one of sputtering, printing, spraying, electric plating, electricless plating, and chemical vapor deposition.

8. A system, comprising:
an actuator element having a generally ‘U’-shaped structure, the actuator element including a support frame of a first material;
a coating at least partially encapsulating the actuator element to prevent particle generation, the coating comprising a second material; and
a slider element adapted to be coupled to the actuator element.

9. The system of claim 8, wherein the actuator element is a micro-actuator.

10. The system of claim 9, wherein the micro-actuator is a piezoelectric micro-actuator.

11. The system of claim 8, further comprising a suspension element coupled to the actuator element.

12. The system of claim 8, further comprising a hard drive to be read by the slider element.

13. The system of claim 8, wherein the first material is Zirconia.

14. The system of claim 8, wherein the second material is softer than the first material.

15. The system of claim 8, wherein the second material is selected from a group consisting of an epoxy, a resin, and a soft metal.

16. The system of claim 8, wherein the coating is applied by one of sputtering, printing, spraying, electric plating, electricless plating, and chemical vapor deposition.

17. A method, comprising:
at least partially encapsulating an actuator element having a generally ‘U’-shaped structure with a coating to prevent particle generation, the actuator element including a support frame of a first material and the coating comprising a second material.

18. The method of claim 17, wherein the actuator element is a micro-actuator.

19. The method of claim 18, wherein the micro-actuator is a piezoelectric micro-actuator.

20. The method of claim 17, wherein the first material is Zirconia.

21. The method of claim 17, wherein the second material is softer than the first material.

22. The method of claim 17, wherein the second material is selected from a group consisting of an epoxy, a resin, and a soft metal.

23. The method of claim 17, wherein the coating is applied by one of sputtering, printing, spraying, electric plating, electricless plating, and chemical vapor deposition.

24. The method of claim 17, further including coupling a pair of piezoelectric beams to the support frame after the application of the coating.
